(19) United States
(12) Patent Application Publication
(10) Pub. No.: US 2004/0234202 A1
(43) Pub. Date: Nov. 25, 2004

(54) Optical fiber module and method for manufacturing the same, and image display unit

(75) Inventors: Ko Sato, Fukaya-shi (JP); Akio Onuki, Yokohama-shi (JP)

Correspondence Address: PILLSBURY WINTHROP, LLP, P.O. BOX 10500, MCLEAN, VA, 22102, US

(73) Assignee: KABUSHIKI KAISHA TOSHIBA, Tokyo (JP)

(21) Appl. No.: 10/801,133

(22) Filed: Mar. 16, 2004

(30) Foreign Application Priority Data
Mar. 18, 2003 (JP) 2003-074127

(51) Int. Cl. G02B 6/26

(52) U.S. Cl. 385/39

(57) ABSTRACT

An optical fiber module according to the present invention holds an optical fiber made by an ordinary manufacturing means between two glass substrates with a coefficient of thermal expansion approximately equal to that of a cladding material of the optical fiber, these substrates being heated up to a predetermined temperature higher than a glass transition temperature of the optical fiber, and pressurized by a predetermined pressure to taper the optical fiber, thereby improving the coupling with a light-emitting element such as a semiconductor laser.

### CROSS-REFERENCE TO RELATED APPLICATIONS

This application is based upon and claims the benefit of priority from prior Japanese Patent Application No. 2003-074127, filed Mar. 18, 2003, the entire contents of which are incorporated herein by reference.

### BACKGROUND OF THE INVENTION

1. Field of the Invention

The present invention relates to an optical fiber module which makes it possible to couple the lights output from light-emitting elements, particularly from large-output semiconductor lasers, and a method of manufacturing the same, and an image display unit.

2. Description of the Related Art

Jpn. Pat. Appln. KOKAI Publication No. 9-96729 discloses an optical fiber module, in which a taper fiber shaped elliptical in the incident end face, and changed gradually to be circular is considered as a means for applying an asymmetrically spreading light output from a semiconductor laser to an optical fiber with a small loss.

In the technique described in the Jpn. Pat. Appln. KOKAI Publication No. 9-96729, it is necessary to make a trough hole previously in the cladding of an optical fiber in the length direction of the optical fiber. Making a through hole in a fiber with a very small diameter is difficult, and leads to the problem of increased cost.

### BRIEF SUMMARY OF THE INVENTION

According to an aspect of the present invention, there is provided an optical fiber module comprising an optical fiber which has a taper form shaped elliptical in the cross section of one end face of a core and cladding and changed gradually to be circular as separating away from the end face; a holding member which holds the optical fiber in the predetermined length from the end face or the whole body from the side of the optical fiber, and has a coefficient of thermal expansion approximately equal to the value of a coefficient of thermal expansion of the cladding material of the optical fiber; and a sealing material which fills a gap between the optical fiber and the holding member.

According to another aspect of the present invention, there is provided a method of manufacturing an optical fiber module comprising a first step of placing an optical fiber between substrates having a coefficient of thermal expansion approximately equal to a coefficient of thermal expansion of a cladding material of the optical fiber; a second step of heating the substrates and the optical fiber placed between the substrates to a temperature higher than a glass transition temperature of a core material and a glass transition temperature of a cladding material of the optical fiber; a third step of applying a predetermined pressure in the direction almost vertical to the bonded surface of the glass substrates while maintaining the temperature; a fourth step of filling adhesive material in a gap between the optical fiber and the holding member, and bonding them; and a fifth step of polishing the end face together with the substrates holding the optical fiber.

According to another aspect of the present invention, there is provided a method of manufacturing an optical fiber module comprising a first step comprising a step of placing an optical fiber between substrates having a coefficient of thermal expansion approximately equal to a coefficient of thermal expansion of a cladding material of the optical fiber, and a step of placing a spacer member having a predetermined thickness in at least one location between the substrates; a second step of heating the substrates, the optical fiber placed between the substrates, and the spacer member to a temperature higher than a glass transition temperature of a core material and a glass transition temperature of a cladding material of the optical fiber; a third step of applying a predetermined pressure in the direction almost vertical to the bonded surface of the glass substrates while maintaining the temperature; a fourth step of filling adhesive material in a gap between the optical fiber and the holding member, and bonding them; and a fifth step of polishing the end face of the optical fiber together with the substrates holding the optical fiber.

According to another aspect of the present invention, there is provided a method of manufacturing an optical fiber module comprising a first step comprising a step of placing an optical fiber between substrates having a coefficient of thermal expansion approximately equal to a coefficient of thermal expansion of a cladding material of the optical fiber, and a step of placing between the substrates a predetermined amount of a low fusing point glass material having a fusing point sufficiently lower than a glass transition temperature of a core material and a glass transition temperature of a cladding material of the optical fiber; a second step of heating the substrates, the optical fiber placed between the substrates, and the low fusing point glass material to a temperature higher than a glass transition temperature of a core material and a glass transition temperature of a cladding material of the optical fiber; a third step of applying a predetermined pressure in the direction almost vertical to the bonded surface of the glass substrates while maintaining the temperature; a fourth step of polishing the end face of the optical fiber together with the substrates holding the optical fiber.

According to another aspect of the present invention, there is provided a method of manufacturing an optical fiber module comprising a first step comprising a step of placing an optical fiber between substrates having a coefficient of thermal expansion approximately equal to a coefficient of thermal expansion of a clad material of the optical fiber, a step of placing a spacer member having a predetermined thickness in at least one location between the substrates, and a step of placing between the substrates a predetermined amount of a low fusing point glass material having a fusing point sufficiently lower than a glass transition temperature of a core material and a glass transition temperature of a cladding material of the optical fiber; a second step of heating the substrates, the optical fiber placed between the substrates, the spacer member, and the low fusing point glass material to a temperature higher than a glass transition temperature of a core material and a glass transition temperature of a cladding material of the optical fiber; a third step of applying a predetermined pressure in the direction almost vertical to the bonded surface of the glass substrates while maintaining the temperature; a fourth step of polishing the end face of the optical fiber together with the substrates holding the optical fiber.

According to another aspect of the present invention, there is provided an image display unit of the prevent invention comprises fiber laser apparatuses which output R, G and B lights; spatial modulation elements which spatially modulate the R, G and B lights; a synthesizing means which synthesizes the R, G and B lights spatially modulated by the spatial modulation elements; and an optical element which forms the image of the output light of the synthesizing means at a predetermined position; wherein at least one of the fiber laser apparatuses has an optical fiber module constructed as described above and manufactured by the above mentioned method, between a semiconductor laser and an up-conversion fiber.

According to another aspect of the present invention, there is provided an image display unit of the prevent invention comprises fiber laser apparatuses which output R, G and B lights; a white light synthesizing means which collects the R, G and B lights as one light and makes it a white light when viewed macroscopically; a spatial modulation element which spatially modulates the output light of the white light synthesizing means; and an optical element which forms the image of the light modulated spatially by the spatial modulation element at a predetermined position; wherein the fiber laser apparatuses have an optical fiber module constructed as described above and manufactured by the above mentioned method, between a semiconductor laser and an up-conversion fiber.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the embodiments given below, serve to explain the principles of the invention.

FIG. 1 is a schematic illustration explaining an optical fiber module according to the present invention;

FIG. 2A is a side view of the optical fiber module shown in FIG. 1;

FIG. 2B is a top view of the optical fiber module shown in FIG. 1;

FIG. 2C is an end view of one end side of the optical fiber module shown in FIG. 1;

FIG. 2D is an end view of the other end side of the optical fiber module shown in FIG. 1;

FIGS. 3A and 3B are schematic illustrations explaining an example of usage of the optical fiber module shown in FIG. 1;

FIGS. 4A to 4F are schematic illustrations explaining a process of manufacturing the optical fiber module according to the present invention shown in FIG. 1 and FIGS. 2A to 2D;

FIG. 5 is a schematic diagram explaining graphically an example of a pressurizing method used in the pressurizing process shown in FIG. 4C in the method of manufacturing an optical fiber module shown in FIGS. 4A to 4F;

FIG. 6 is a schematic illustration explaining a profile example of heating and pressurizing used in FIGS. 4A to 4F;

FIG. 7 is a schematic illustration explaining another example of an optical fiber module according to the present invention;

FIG. 8A is a side view of the optical fiber module shown in FIG. 7;

FIG. 8B is a top view of the optical fiber module shown in FIG. 7;

FIG. 8C is an end view of one end side of the optical fiber module shown in FIG. 7;

FIG. 8D is an end view of the other end side of the optical fiber module shown in FIG. 7;

FIGS. 9A to 9F are schematic illustrations explaining a process of manufacturing the optical fiber module according to the present invention shown in FIG. 7 and FIGS. 8A to 8D;

FIG. 10 is a schematic diagram explaining an embodiment of an image display unit using the optical fiber module according to the present invention; and

FIG. 11 is a schematic diagram explaining another embodiment of an image display unit using the optical fiber module according to the present invention.

### DETAILED DESCRIPTION OF THE INVENTION

Hereinafter, detailed explanation will be given on the embodiments of the present invention with reference to the accompanying drawings.

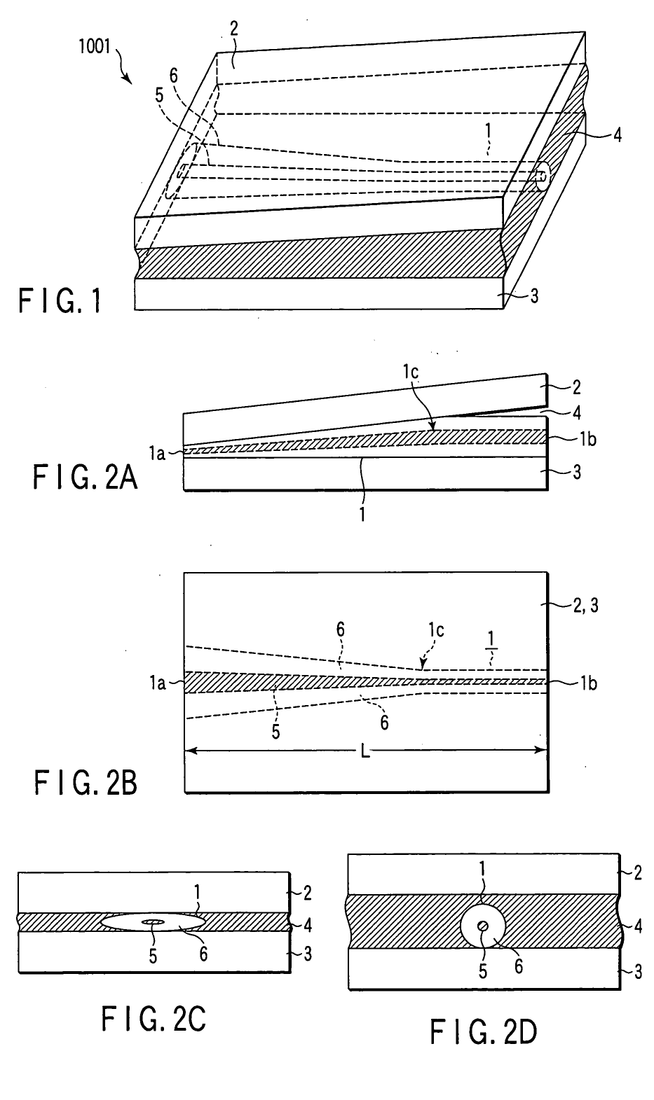

FIG. 1 is a schematic illustration explaining an optical fiber module in an embodiment of the present invention. FIG. 2A is a side view of the optical fiber module shown in FIG. 1. FIG. 2B is a top view of the optical fiber module shown in FIG. 1. FIG. 2C is an end view of one end side of the optical fiber module shown in FIG. 1. FIG. 2D is an end view of the other end side of the optical fiber module shown in FIG. 1.

In FIG. 1, an optical fiber module 1001 includes an optical fiber 1, glass substrates 2, 3 for holding the optical fiber 1 from both sides, and a sealing material which fills a gap between the optical fiber 1 and glass substrates 2, 3.

The optical fiber 1 is made of multi-component glass, for example. The glass transition temperature of a core 5 and clad 6 of the optical fiber 1 is approximately 520° C. The coefficient of thermal expansion of the core 5 and cladding 6 is approximately 85×10⁻⁷ (1/K)

The glass substrates 2 and 3 holding the optical fiber 1 are made by a plate silicate glass, and the coefficient of thermal expansion is 90×10⁻⁷ (1/K).

The sealing material 4 filled in the gap between the optical fiber 1 and the glass substrates 2, 3 holding the optical fiber 1 is epoxy adhesive, for example.

The optical fiber 1 has a flat collapsed form in one end face 1a as shown in FIG. 2C. The form of the core 5 of the optical fiber 1 in the flat part (end face 1a) is elliptical with a short axis radius of approximately 4 μm and a long axis radius of approximately 25 μm.

The length L in the optical axis direction is approximately 25-mm. The optical fiber 1 has a tapered form with the cross section approaching gradually to a φ20 μm circle from the end face 1a to a position 1c of approximately 15 mm. It has an ordinary circular cross section of φ20 μm in the area of approximately 10 mm to the other end face 1b.

Further, the end faces 1a and 1b of the optical fiber 1 are polished together with the glass substrates 2/3 and sealing material 4, and formed as a mirror surface.

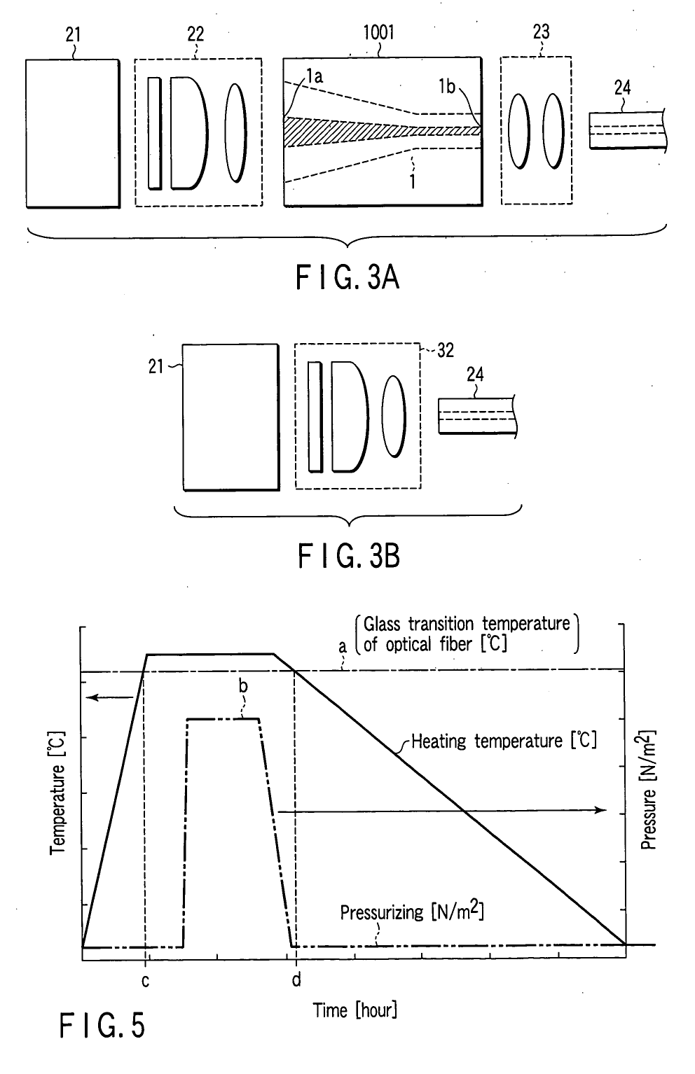

Now, explanation will be given simply on an example of use form of the above-mentioned fiber module by referring to FIGS. 3A and 3B.

As shown in FIG. 3A, a semiconductor laser 21 and lens optics 22 are provided in the stage before the optical fiber module 1001, and a lens optics 23 is placed in the stage after the optical fiber module 1001, to input a laser beam into an optical fiber 24. The semiconductor laser 21 has an emission light width of approximately 200 μm. The optical fiber 24 has a core diameter of φ20 μm and NA (numerical aperture) of 0.28.

In FIG. 3A, the laser beam output from the semiconductor laser 21 is condensed and applied to the elliptical core at the end face 1a by the lens optics 22, and the beam shape is gradually changed from elliptic to circular with little loss, while being transmitted through the optical fiber 1 in the module 1001, and outputted from the end face 1b.

The output light from the end face 1b of the optical fiber 1 in the optical fiber module 1001 is applied through the lens optics 23 to the optical fiber 24 or a final target. A reflection-free film is formed on the end faces 1a and 1b of the optical fiber module 1001, so that the end faces do not reflect the laser beam output from the semiconductor laser 21, and a loss caused by reflection is reduced. Compared with the case where the light is applied to the optical fiber 24 only through the lens optics 32 as shown in FIG. 3B, it has been confirmed that use of the optical fiber module 1001 improves the optical coupling efficiency by 1-2 dB.

As described above, according to the optical fiber module of the invention, it is possible to obtain efficient optical coupling by converting the semiconductor laser output spreading asymmetrically from a wide range, from elliptical to circular.

As an optical fiber, an example made of multi-component glass has been explained above, but various ordinary optical fibers are also applicable.

As a member for holding an optical fiber, a glass substrate using plate silicate glass is used, but any material with a coefficient of thermal expansion close to that of a cladding of an optical fiber is permitted, and various kinds of glass and ceramic can be used.

A sealing material is not limited to epoxy adhesive, and various ordinary adhesives can be used.

Further, the diameter and cross section of an optical fiber, and coefficient of thermal expansion of each member indicated in this embodiment are merely examples, and they can be optionally changed according to the purpose of the optical fiber module and the kinds of materials.

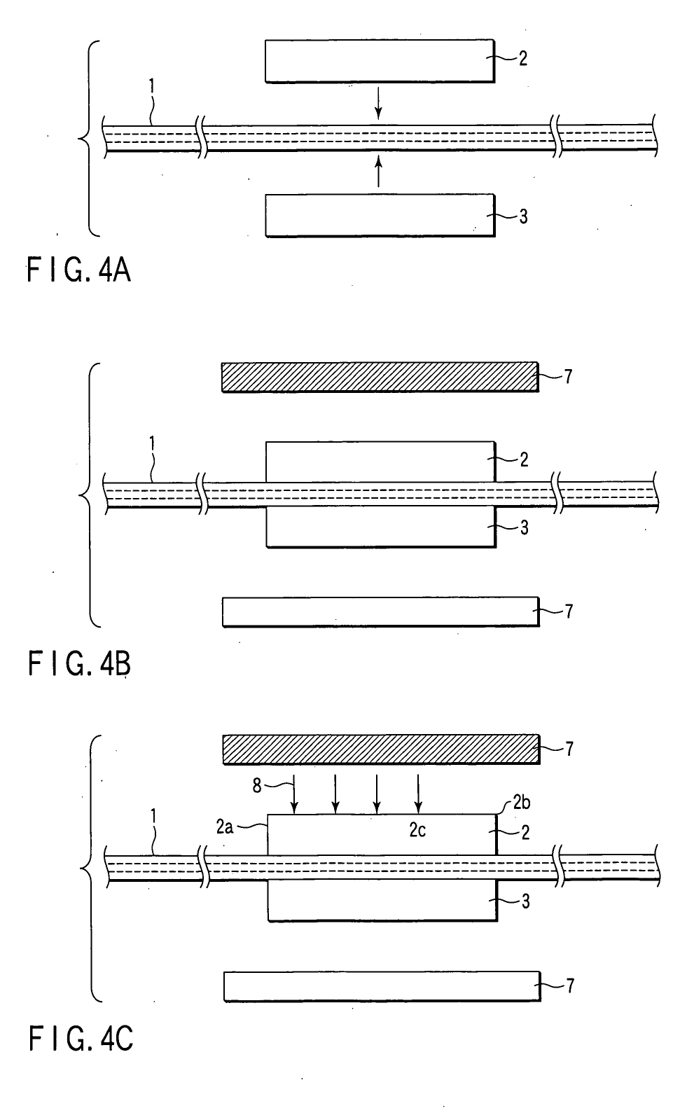

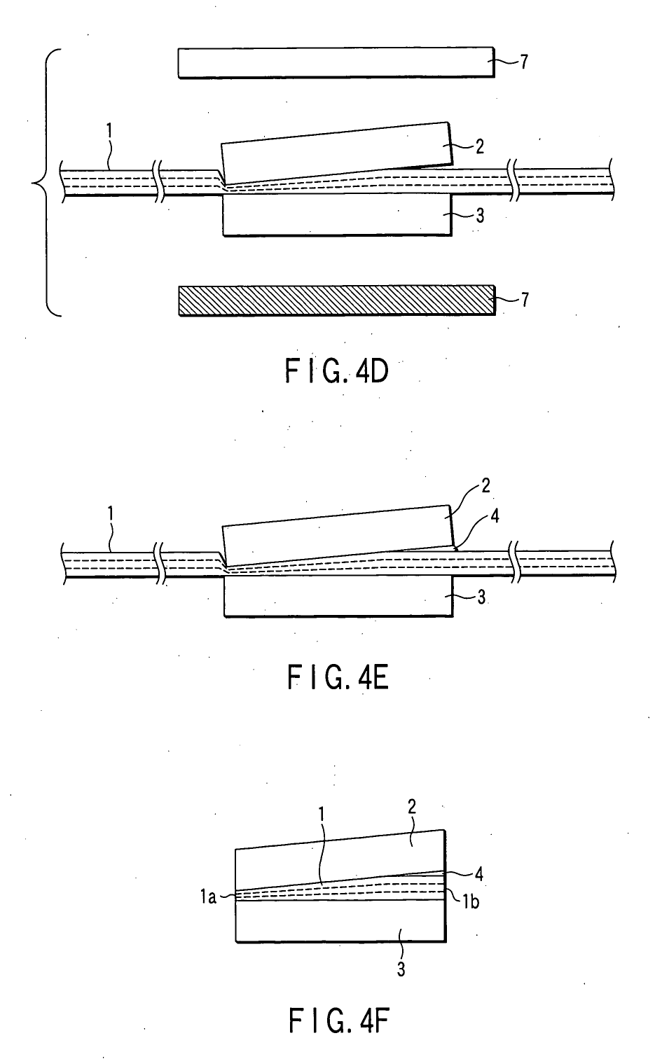

Next, explanation will be given on a method of manufacturing the optical fiber module of the invention with reference to FIG. 4A to FIG. 4F. FIG. 4A to FIG. 4F are side views seen from the same direction. First, prepare the optical fiber 1 made by using an ordinary means, and hold a part of the optical fiber between the glass substrates 2 and 3 made of plate silicate glass (FIG. 4A).

In this time, if the optical fiber 1 is coated with a resin film, remove it previously and make the cladding bare in the area held by the glass substrates 2 and 3.

Next, heat the glass substrates 2, 3 and the optical fiber 1 held therebetween at a predetermined temperature by using a heater 7 (FIG. 4B).

Further, keep the glass substrates 2, 3 and the optical fiber 1 held therebetween in being heated, and apply a predetermined pressure 8 to the glass substrate 2 in the direction almost vertical to the bonded surface of the glass substrates 2 and 3 (FIG. 4C).

In this time, the pressure 8 is to be applied to collapse heavily the optical fiber 1 in the side of one end face 2a, and not to generate a pressure in the optical fiber 1 in the area from the position 2c inside of the glass substrate 2 to the other end face 2b.

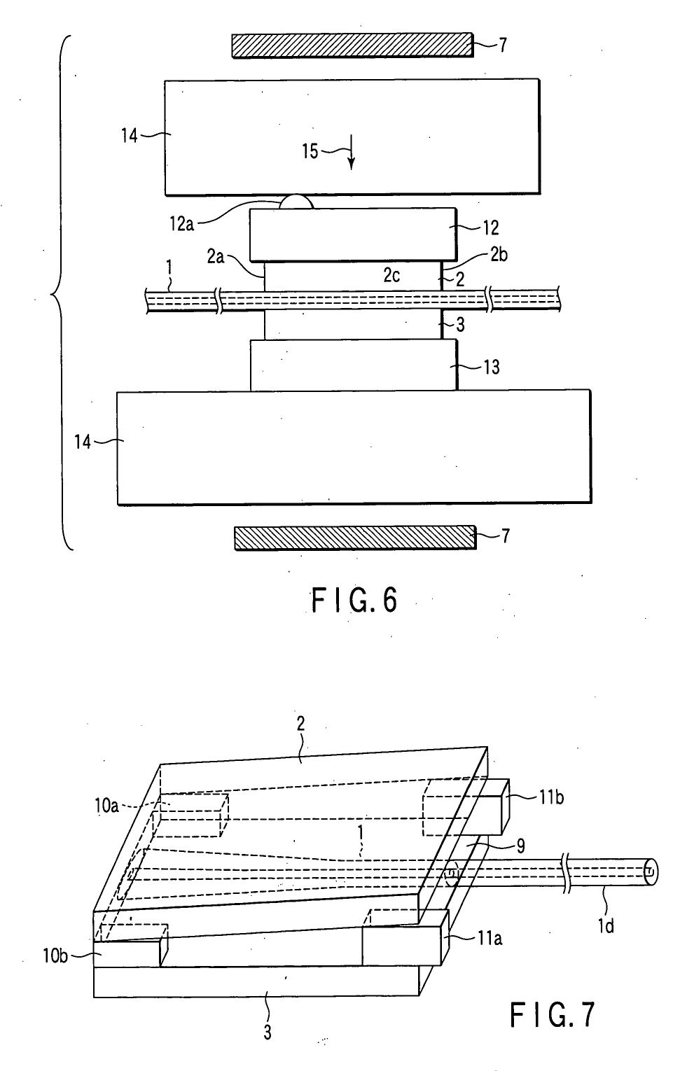

FIG. 6 shows an example of a method of pressuring used in the pressurizing process shown in FIG. 4C. In this example, the glass substrates 2 and 3 holding the optical fiber 1 are further held by alumina substrates 12 and 13, and they are collectively pressurized by a press unit 14 in the direction of arrow 15. In this time, the alumina substrate 12 is provided with a projection 12a in the press unit side, and by placing this projection 12a at a position close to the end face 2a of the glass substrate 2, the pressure is applied so that the optical fiber 1 is heavily collapsed in the side of end face 2a and not collapsed in the side of end face 2b. The alumina substrate prevents the heated glass substrate from being fused to the press unit, and at the same time helps smooth tapering of the glass substrate without bending when pressurized. But, this pressurizing method is just one example. The present invention is not to be limited to this method.

Next, stop pressurizing and heating (FIG. 4D), fill the sealing material 4 in the gap between the glass substrates 2, 3 and optical fiber 1 (FIG. 4E), and bond the optical fiber 1 firmly to the glass substrates 2 and 3.

Finally, as shown in FIG. 4F, polish the end faces 1a and 1b on both sides of the optical fiber 1 together with glass substrates 2, 3 bonded to the optical fiber 1, and make the surface like a mirror, thereby completing the optical fiber module shown in FIG. 1 and FIG. 2A to FIG. 2D.

Next, explanation will be given on an example of the profile of heating and pressurizing the optical fiber 1 by refereeing to FIG. 5.

Increase the temperature of the optical fiber held by the glass substrates 2 and 3 up to the glass transition temperature of the optical fiber indicated by a chain line a. While maintaining this temperature, pressurize the glass substrate 2 as indicated by a chain double-dashed line b. The pressurizing in this example is to be within the period indicated by dashed lines c and d where the temperature higher than the glass transition temperature is kept. By cooling down to an ordinary temperature after the pressurizing is finished, the pressurized and deformed state is held. The material of the optical fiber, and kinds of glass substrates holding the optical fiber can be optionally changed according to a desired taper form of the optical fiber.

In this embodiment, as a method of pressurizing an optical fiber, two glass substrates are used to hold the optical fiber, and one of the glass substrate is pressurized while the other one is being fixed. However, it is permitted to pressurize two glass substrates simultaneously.

It is also permitted not to use two glass substrates, but to insert an optical fiber into a hollow glass member, and pressurize that glass member. It is also permitted to hold a plurality of optical fiber between glass plates and process them collectively.

Further, both end faces of an optical fiber are polished together with the holding glass substrates, but it is also possible to polish only the end face of the side collapsed elliptically, and leave the other end of the circular shaped side as it were.

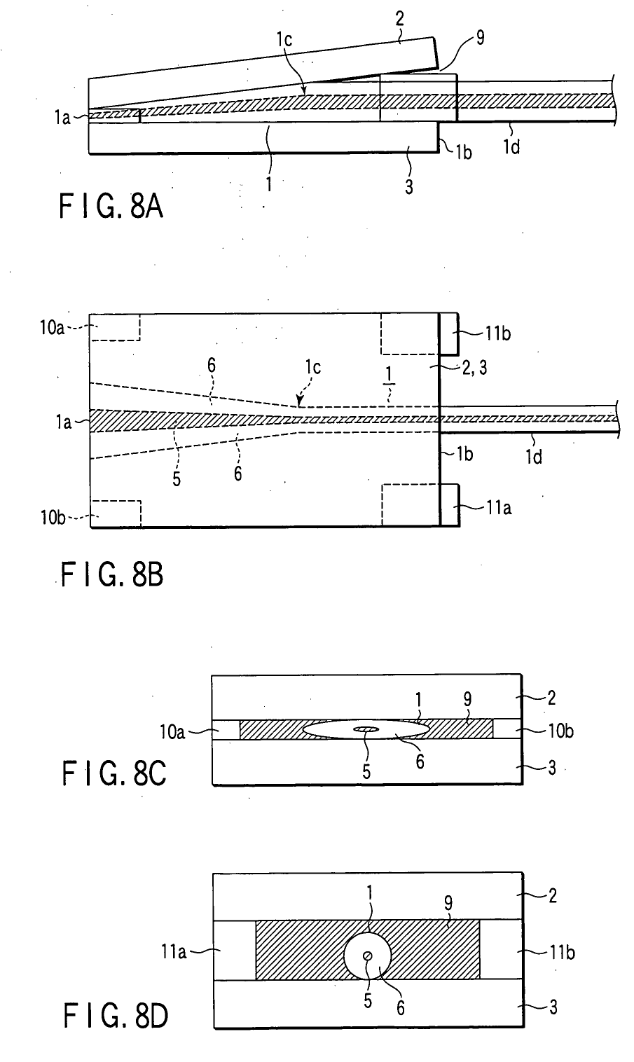

FIG. 7 and FIG. 8A to FIG. 8D explain schematically another embodiment of the optical fiber module of the invention. FIG. 7 is a whole perspective view. FIG. 8A is a side view of the optical fiber module shown in FIG. 7. FIG. 8B is a top view of the optical fiber module show in FIG. 7. FIG. 8C is an end view of one end side of the optical fiber module shown in FIG. 7. FIG. 8D is an end view of the other end side of the optical fiber module shown in FIG. 7. The same reference numerals are given to the same function parts as those in FIG. 2A to FIG. 2D.

The embodiment shown in FIG. 7 and FIG. 8A to FIG. 8D is different from the first embodiment in that the optical fiber 1 is projected from the part 1b and extended as an extension 1d, a sealing material 9 is glass having a lower fusing point than the glass transition temperature of the core material of the optical fiber 1 and the glass transition temperature of the cladding material, and spacer members 10a, 10b, 11a, 11b are inserted into each corner between the glass substrates 2, 3 used as holding members. In the embodiment shown in FIG. 7 and FIG. 8A to FIG. 8D, the spacer members 10a, 10b, 11a, 11b are made of glass material having a coefficient of thermal expansion approximately equal to the coefficient of thermal expansion of the glass substrates 2, 3 (i.e., approximately equal to the coefficient of thermal expansion of the optical fiber material). The spacer members 10a and 10b are about 60 μm thick, and the spacer members 11a and 11b are about 150 μm thick. The characteristics and specifications of the optical fiber 1 and glass substrates 2, 3 are the same as those described in the first embodiment. The tapered part of the optical fiber 1 is also the same as in the first embodiment. In this embodiment, in addition to the effect of the first embodiment which enables to connect efficiently the semiconductor laser output spreading asymmetrically from a wide range, it is made easy to connect the output light to other optical fibers by the extension 1d formed by projecting the ordinary circular shaped part of the optical fiber 1, and the number of applicable apparatus is increased.

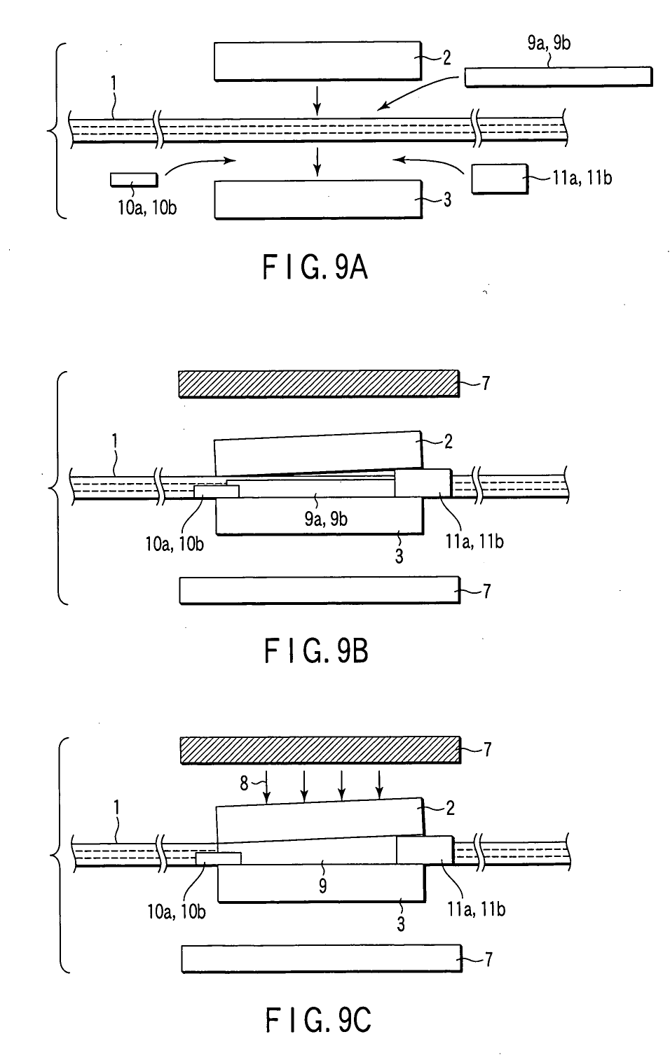

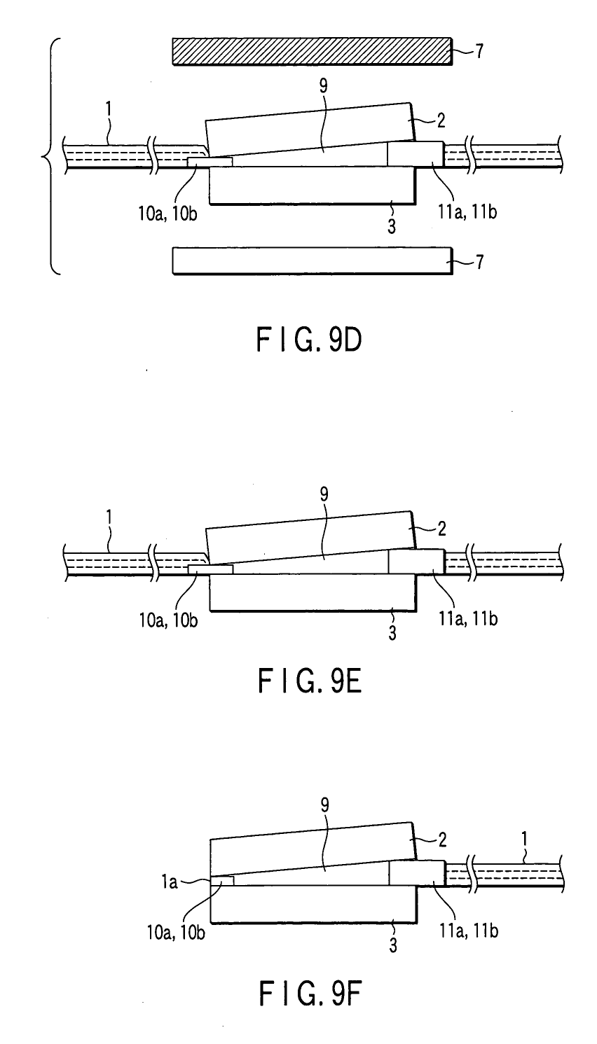

Next, explanation will be given on a method of manufacturing the optical fiber module of the embodiment shown in FIG. 7 and FIG. 8A to FIG. 8D with reference to FIG. 9A to FIG. 9F.

First, prepare the optical fiber 1 made by using an ordinary means, hold a part of the optical fiber between the glass substrates 2 and 3, and place spacers 10a, 10b, 11a, 11b at corners of the glass substrates 2 and 3. (FIG. 9A) In this time, if the optical fiber 1 is coated with a resin film, remove it previously and make the cladding bare in the area held by the glass substrates 2 and 3. The characteristics of the material of the optical fiber 1 and glass substrates 2, 3 are as described above.

Next, heat the glass substrates 2, 3 and the optical fiber 1 held therebetween at a predetermined temperature by using a heater 7 (FIG. 9B).

Further, keep the glass substrates 2, 3 and the optical fiber 1 held therebetween in being heated, and apply a predetermined pressure 8 to the glass substrate 2 in the direction almost vertical to the bonded surface of the glass substrates 2 and 3 (FIG. 9C).

In this time, though it is not shown, the glass substrate 3 is fixed, and the pressure 8 is to be applied to collapse heavily the optical fiber 1 in the side of one end face 2a, and not to generate a pressure in the optical fiber 1 in the area from the position 2c inside of the glass substrate 2 to the other end face 2b. Since the spacer members 10a, 10b, 11a and 11c are being placed between the glass substrates 2 and 3, the fiber can be tapered stably and accurately, even in the state that the pressure 8 is applied evenly all over the glass substrate.

Next, stop pressurizing and heating (FIG. 9D, FIG. 9E), and finally, as shown in FIG. 9F, polish the end face 1a with the elliptical cross section of the optical fiber 1 together with glass substrates 2, 3 bonded to the optical fiber 1, and make the surface like a mirror, thereby completing the optical fiber module shown in FIG. 7 and FIG. 8A to FIG. 8D. Before executing the process of heating and processing, insert glass materials 9a and 9b of a low fusing point between the glass substrates 2 and 3, together with the optical fiber. The glasses 9a and 9b become a fused glass material 9 when heated, and the glass material 9 fills the gap between the glass substrates 2 and 3. Thus, the glass optical fiber 1 and glass substrates 2, 3 are bonded stably by the low fusing point glass material when cooled.

Therefore, it becomes possible to omit a step of filling adhesive after the process of heating and processing as required in the first embodiment, and avoid a trouble of breaking a processed optical fiber by a handling mistake before filling an adhesive.

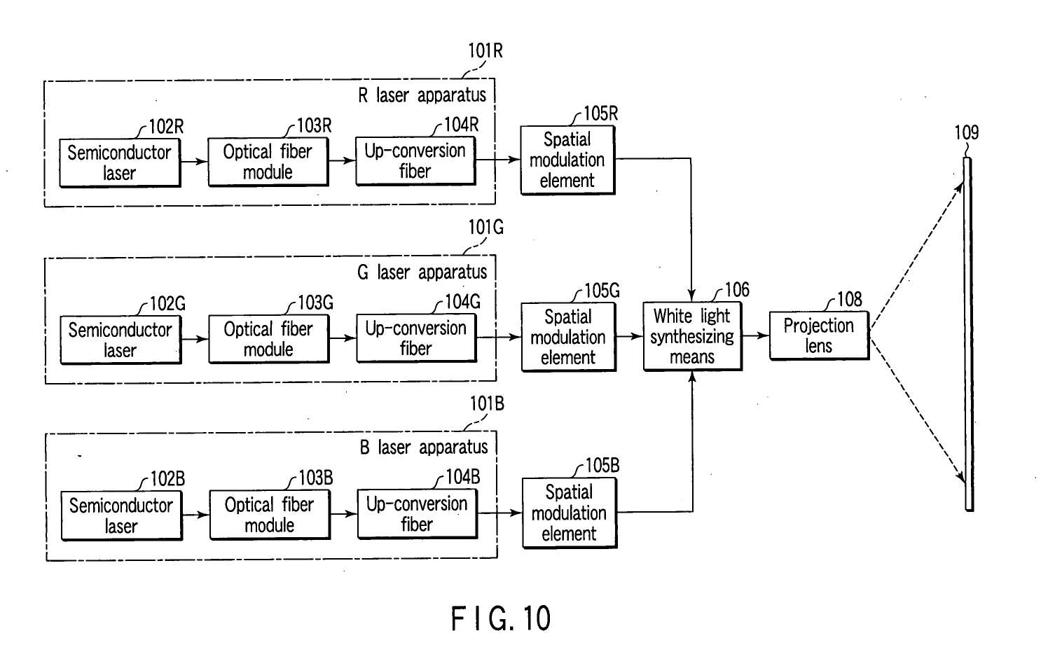

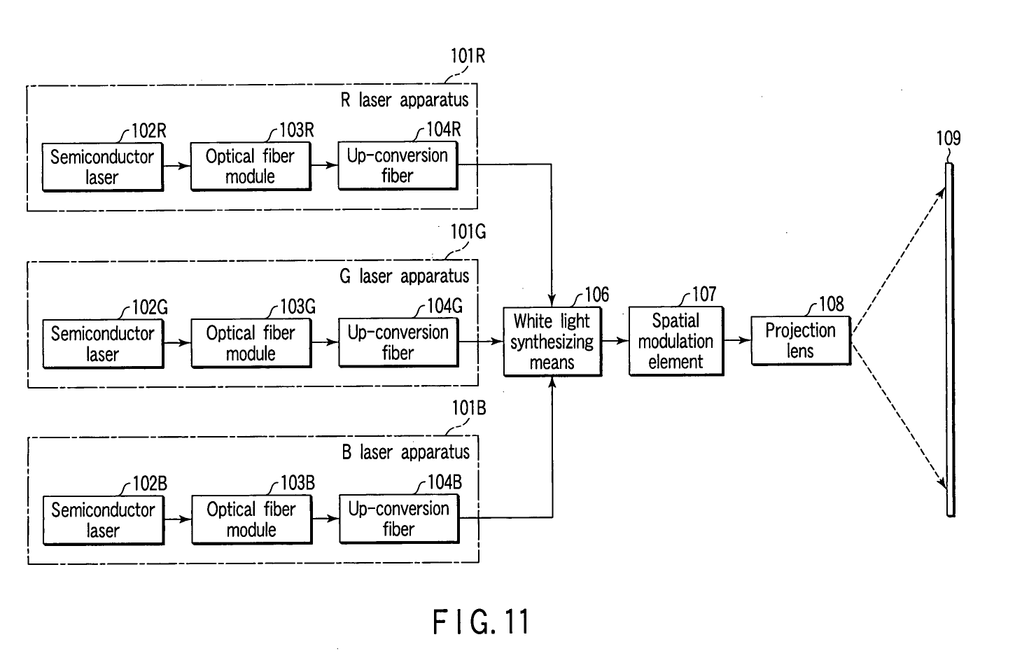

FIG. 10 is a schematic diagram of an embodiment of an image display unit using the optical fiber module of the present invention.

The reference numerals 101R, 101G and 101B denote fiber laser apparatuses to obtain R (red), G (green) and B (blue) output lights.

The fiber laser apparatuses 101R, 101G and 101B comprise semiconductor lasers 102R, 102G and 102B, optical fiber modules 103R, 103G and 103B, and up-conversion fibers 104R, 104R and 104B. The optical fiber modules 103R, 103G and 103B are configured as shown in FIG. 1 and FIG. 2A to FIG. 2D.

Now, brief explanation will be given on the operation principle of a fiber laser taking the fiber laser apparatus 101R as an example.

In the fiber laser apparatus 101R, the laser beam output from the semiconductor laser 102R is applied to the up-conversion fiber 104R through the optical fiber module 103R, and the incident laser beam is converted to an R (red) laser beam with a different wavelength and output.

By using the optical fiber modules shown in FIG. 1 and FIG. 2A to FIG. 2D, the power of the laser beam applied to the up-conversion fiber 104R can be increased.

The wavelength of the laser beam output finally from the up-conversion fiber can be changed according to the types of the up-conversion fiber and the characteristics of mirrors (not shown) placed at both ends of the up-conversion fiber. This makes it possible to take out laser beams with G (green) and B (blue) wavelengths from the fiber laser apparatus 101g and 101B.

It is also possible to convert further the wavelength of the output laser beam by connecting the up-conversion fiber in multi-stage, and applying the laser beam once converted to a different wavelength to the up-conversion fiber in the later stage.

Though a means to apply a laser beam from the semiconductor laser 102R to the optical fiber module 103R, and a means to apply a laser beam to the optical fiber module and up-conversion fiber are not shown in FIG. 10, it is possible to use ordinary optical connection means such as a lens or other optical parts, or a butt joint connection between the semiconductor laser and optical fiber module, and between the optical fiber module and up-conversion fiber.

Next, explanation will be explained on the configuration of the image display unit. The R, G and B lights output from the laser apparatus 101R, 101G and 101B are applied to liquid crystal panels 105R, 105G and 105B, and accepts spatial modulation. The spatially modulated R, G and B lights are synthesized by a synthesizing means 106 such as a dichroic prism, and applied to a projection lens 108. This input light is projected and displayed as an image on a screen 109 by the projection lens 108. In this embodiment, a liquid crystal panel is used as a spatial modulation element, but the present is not limited to this configuration. Use of DMD or other ordinary spatial modulation elements is also permitted.

FIG. 11 is a schematic diagram of another embodiment of an image display unit using the optical fiber module of the present invention.

In this embodiment, the R, G and B lights output from the fiber laser apparatus 101R, 101G and 101B are applied to a white light synthesizing means 106, which collects the input lights as one light and makes it a white light when viewed macroscopically (generally).

This white light is applied to a liquid crystal panel 107, and projected and displayed as an image on a screen 109 by the projection lens 108.

In this embodiment, a liquid crystal panel is used as a spatial modulation element, but the invention is not limited to this configuration. Use of DMD or other ordinary spatial modulation elements is also permitted.

An optical element such as a dichroic prism is used for a white light synthesizing means, but it is also permitted to bind the optical fibers which output R, G and B lights.

In each above-mentioned image display unit using the optical fiber module of the present invention, a laser output with a desired wavelength can be projected onto a screen with a small loss, and as a result the power consumption to obtain the output light with the luminance required to display an image can be decreased.

FIG. 10 and FIG. 11 explain the examples using the optical fiber module configured as shown in FIG. 2A to FIG. 2D. It is off course permitted to use the optical fiber module configured as shown in FIG. 7 and FIG. 8A to FIG. 8D.

As explained above, according to the present invention, it is possible to input an asymmetrically spreading light emitted from a semiconductor laser to an optical fiber with a small loss, by means of an optical fiber module formed as a single unit.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An optical fiber comprising:
an optical fiber which has a taper form shaped elliptical in the cross section of one end face of a core and cladding and changed gradually to be circular as separating away from the end face;
a holding member which holds the optical fiber in the predetermined length from the end face or the whole body from the side of the optical fiber, and has a coefficient of thermal expansion approximately equal to the value of a coefficient of thermal expansion of the cladding material of the optical fiber; and
a sealing material which fills a gap between the optical fiber and the holding member.

2. A optical fiber module according to claim 1, wherein at least one of the end faces of the optical fiber is polished together with the holding member.

3. A optical fiber module according to claim 1, wherein the holding member is glass or ceramic material.

4. A optical fiber module according to any one of claim 1 to 3, wherein the sealing material is glass having a fusing point sufficiently lower than a glass transition temperature of a core material and a glass transition temperature of a cladding material of the optical fiber.

5. A method of manufacturing an optical fiber module comprising:
a first step of placing an optical fiber between substrates having a coefficient of thermal expansion approximately equal to a coefficient of thermal expansion of a cladding material of the optical fiber;
a second step of heating the substrates and the optical fiber placed between the substrates to a temperature higher than a glass transition temperature of a core material and a glass transition temperature of a cladding material of the optical fiber;
a third step of applying a predetermined pressure in the direction almost vertical to the bonded surface of the glass substrates while maintaining the temperature;
a fourth step of filling adhesive material in a gap between the optical fiber and the holding member, and bonding them; and
a fifth step of polishing the end face of the optical fiber together with the substrates holding the optical fiber.

6. A method of manufacturing an optical fiber module comprising:
a first step comprising a step of placing an optical fiber between substrates having a coefficient of thermal expansion approximately equal to a coefficient of thermal expansion of a cladding material of the optical fiber, and a step of inserting a spacer member having a predetermined thickness in at least one location between the substrates;
a second step of heating the substrates, the optical fiber placed between the substrates, and the spacer member to a temperature higher than a glass transition temperature of a core material and a glass transition temperature of a cladding material of the optical fiber;
a third step of applying a predetermined pressure in the direction almost vertical to the bonded surface of the glass substrates while maintaining the temperature;
a fourth step of filling adhesive material in a gap between the optical fiber and the holding member, and bonding them; and
a fifth step of polishing the end face of the optical fiber together with the substrates holding the optical fiber.

7. A method of manufacturing an optical fiber module comprising:
a first step comprising a step of inserting an optical fiber between substrates having a coefficient of thermal expansion approximately equal to a coefficient of thermal expansion of a cladding material of the optical fiber, and a step of inserting between the substrates a predetermined amount of a low fusing point glass material having a fusing point sufficiently lower than a glass transition temperature of a core material and a glass transition temperature of a cladding material of the optical fiber;
a second step of heating the substrates, the optical fiber inserted between the substrates, and the low fusing point glass material to a temperature higher than a glass transition temperature of a core material and a glass transition temperature of a cladding material of the optical fiber;
a third step of applying a predetermined pressure in the direction almost vertical to the bonded surface of the glass substrates while maintaining the temperature; and
a fourth step of polishing the end face of the optical fiber together with the substrates holding the optical fiber.

8. A method of manufacturing an optical fiber module comprising:
a first step comprising a step of inserting an optical fiber between substrates having a coefficient of thermal expansion approximately equal to a coefficient of thermal expansion of a cladding material of the optical fiber, a step of inserting a spacer member having a predetermined thickness in at least one location between the substrates, and a step of inserting between the substrates a predetermined amount of a low fusing point glass material having a fusing point sufficiently lower than a glass transition temperature of a core material and a glass transition temperature of a cladding material of the optical fiber;
a second step of heating the substrates, the optical fiber placed between the substrates, the spacer member, and the low fusing point glass material to a temperature higher than a glass transition temperature of a core material and a glass transition temperature of a cladding material of the optical fiber;
a third step of applying a predetermined pressure in the direction almost vertical to the bonded surface of the glass substrates while maintaining the temperature; and
a fourth step of polishing the end face of the optical fiber together with the substrates holding the optical fiber.

9. An image display unit comprising:
fiber laser apparatuses which output R, G and B lights;
spatial modulation elements which spatially modulate the R, G and B lights;
a synthesizing means which synthesizes the R, G and B lights spatially modulated by the spatial modulation elements; and
an optical element which forms the image of the output light of the synthesizing means at a predetermined position;
wherein at least one of the fiber laser apparatuses has an optical fiber module manufactured by the method of claim 5, between a semiconductor laser and an up-conversion fiber.

10. An image display unit comprising:
fiber laser apparatuses which output R, G and B lights;
a white light synthesizing means which collects the R, G and B lights as one light and makes it a white light when viewed macroscopically;
a spatial modulation element which spatially modulates the output light of the white light synthesizing means; and
an optical element which forms the image of the light modulated spatially by the spatial modulation element at a predetermined position;
wherein at least on of the fiber laser apparatus has an optical fiber module manufactured by the method of claim 5, between a semiconductor laser and an up-conversion fiber.

11. An image display unit comprising:
fiber laser apparatuses which output R, G and B lights;
spatial modulation elements which spatially modulate the R, G and B lights;
a synthesizing means which synthesizes the R, G and B lights spatially modulated by the spatial modulation elements; and
an optical element which forms the image of the output light of the synthesizing means at a predetermined position;
wherein at least one of the fiber laser apparatuses has an optical fiber module manufactured by the method of claim 6, between a semiconductor laser and an up-conversion fiber.

12. An image display unit comprising:
fiber laser apparatuses which output R, G and B lights;
a white light synthesizing means which collects the R, G and B lights as one light and makes it a white light when viewed macroscopically;
a spatial modulation element which spatially modulates the output light of the white light synthesizing means; and
an optical element which forms the image of the light modulated spatially by the spatial modulation element at a predetermined position;
wherein at least one of the fiber laser apparatus has an optical fiber module manufactured by the method of claim 6, between a semiconductor laser and an up-conversion fiber.

13. An image display unit comprising:
fiber laser apparatuses which output R, G and B lights;
spatial modulation elements which spatially modulate the R, G and B lights;
a synthesizing means which synthesizes the R, G and B lights spatially modulated by the spatial modulation elements; and
an optical element which forms the image of the output light of the synthesizing means at a predetermined position;
wherein at least one of the fiber laser apparatus has an optical fiber module manufactured by the method of claim 7, between a semiconductor laser and an up-conversion fiber.

14. An image display unit comprising:
fiber laser apparatuses which output R, G and B lights;
a white light synthesizing means which collects the R, G and B lights as one light and makes it a white light when viewed macroscopically;
a spatial modulation element which spatially modulates the output light of the white light synthesizing means; and
an optical element which forms the image of the light modulated spatially by the spatial modulation element at a predetermined position;
wherein at least one of the fiber laser apparatuses has an optical fiber module manufactured by the method of claim 7, between a semiconductor laser and an up-conversion fiber.

15. An image display unit comprising:
fiber laser apparatuses which output R, G and B lights;
spatial modulation elements which spatially modulate the R, G and B lights;
a synthesizing means which synthesizes the R, G and B lights spatially modulated by the spatial modulation elements; and
an optical element which forms the image of the output light of the synthesizing means at a predetermined position,
wherein at least one of the fiber laser apparatuses has an optical fiber module manufactured by the method of claim 8, between a semiconductor laser and an up-conversion fiber.

16. An image display unit comprising:
fiber laser apparatuses which output R, G and B lights;
a white light synthesizing means which collects the R, G and B lights as one light and makes it a white light when viewed macroscopically;
a spatial modulation element which spatially modulates the output light of the white light synthesizing means; and
an optical element which forms the image of the light modulated spatially by the spatial modulation element at a predetermined position;
wherein at least one of the fiber laser apparatuses has an optical fiber module manufactured by the method of claim 8, between a semiconductor laser and an up-conversion fiber.
